(19) United States
(12) Patent Application Publication
(10) Pub. No.: US 2006/0103525 A1
(43) Pub. Date: May 18, 2006

(54) Child safety sensor for a vehicle

(75) Inventor: (Belle) Mary Michelle Alger, Des Moines, IA (US)

Correspondence Address: BRETT J. TROUT, PC, 516 WALNUT, DES MOINES, IA, 50309, US

(73) Assignee: Belle enterprises, Inc.

(21) Appl. No.: 10/980,488

(22) Filed: Nov. 3, 2004

(51) Int. Cl. G08B 13/08; B60Q 1/00; G08B 23/00

(52) U.S. Cl. 340/545.8; 340/425.5; 340/573.1

(57) ABSTRACT

A portable, releasable alarm is provided for use in association with a vehicle. The alarm may be secured to a vehicle door for actuation and deactuation by the frame of the door when the door is opened and closed. The alarm is designed so that when the door is opened, a speaker broadcasts a warning advising the driver to check for infants, pets or other valuable cargo.

### BACKGROUND OF THE INVENTION

1. Field of the Invention

The present invention relates in general to a safety alarm and, more particularly, to a safety alarm for reminding a vehicle driver not to leave children or animals unattended in a vehicle.

2. Description of the Prior Art

It is known in the art to provide sensors in vehicles to identify the presence of an occupant within a vehicle, and to warn of inhospitable conditions. Such devices are particularly useful for warning of a condition where a child or a pet may be contained within a vehicle where the temperature increases beyond a predetermined limit. While such prior art devices are valuable, they have several drawbacks.

Such prior art devices, while often effective, are typically expensive and time-consuming to install. Such devices typically utilize the vehicle's electronic system, preventing most consumers from installing the system themselves. Additionally, by requiring the systems to operate on the vehicle's electronic system, if the vehicle's electronic system fails, the device fails as well. Additionally, such systems are often wired to the vehicle's horn and/or lights, necessary for alerting individuals other than the driver, but making an unnecessary amount of commotion for situations where the driver is located close to the vehicle. An additional drawback associated with such devices is that the devices typically do not operate until a predetermined environmental condition has been met, often when the driver is a substantial distance from the vehicle. In a situation where the vehicle is left in a deserted location, even the use of the horn and lights would often be insufficient to alert anyone to a potentially dangerous condition. It would be desirable, therefore, to provide a low-cost device which may be installed directly by the consumer. It would also be desirable to provide a device which would be less obtrusive, but which would be sufficient to indicate a potentially dangerous situation to a driver. It would also be desirable to provide an alarm which would alert a driver before the driver has moved outside of the range of the alarm system. The difficulties encountered in the prior art discussed hereinabove are substantially eliminated by the present invention.

### SUMMARY OF THE INVENTION

In an advantage provided by this invention, a safety alarm is provided which is of a low-cost, lightweight manufacture.

Advantageously, this invention provides a safety alarm which may be installed and serviced by a consumer.

Advantageously, this invention provides a safety alarm which activates before a driver leaves the vicinity of the vehicle to which it is attached.

Advantageously, this invention provides a safety alarm which is unobtrusive, while remaining effective.

Advantageously, in a preferred example of the present invention, a vehicle safety sensor is provided a first sensor and a second sensor, with means for releasably engaging the first sensor with a door of a vehicle, and means for releasably engaging the second sensor with the body of a vehicle. Means are provided for generating a sound and for actuating the sound generating means in response to the first sensor moving in relationship to the second sensor. Preferably, the vehicular safety sensor is adhesively secured to the door of a vehicle. Preferably, when the door is opened, the sensors move relative to one another, thereby connecting a circuit and causing a batty to actuate a voice chip and speaker to sound an alert to the driver.

### BRIEF DESCRIPTION OF THE DRAWINGS

The present invention will now be described, by way of example, with reference to the accompanying drawings in which:

FIG. 1 illustrates a side elevation in partial phantom, showing the safety alarm of the present invention installed in a vehicle;

FIG. 2 illustrates a perspective view of the present invention coupled to a door of a vehicle;

FIG. 3 illustrates an exploded perspective view of the non-electrical elements of the alarm of the present invention;

FIG. 4 illustrates a top perspective view of the alarm of the present invention shown with the adhesive strip removed;

FIG. 5A illustrates a side elevation in cross-section of the switch of the present invention when the alarm is actuated;

FIG. 5B illustrates a side elevation in cross-section of the switch of the present invention when the alarm is actuated;

FIG. 6A illustrates a side elevation in cross-section of an alternative switch when the alarm is not actuated;

FIG. 6B illustrates a side elevation in cross-section of an alternative switch when the alarm is actuated;

FIG. 7 illustrates a rear perspective view of an alternative alarm of the present invention coupled to a door latch;

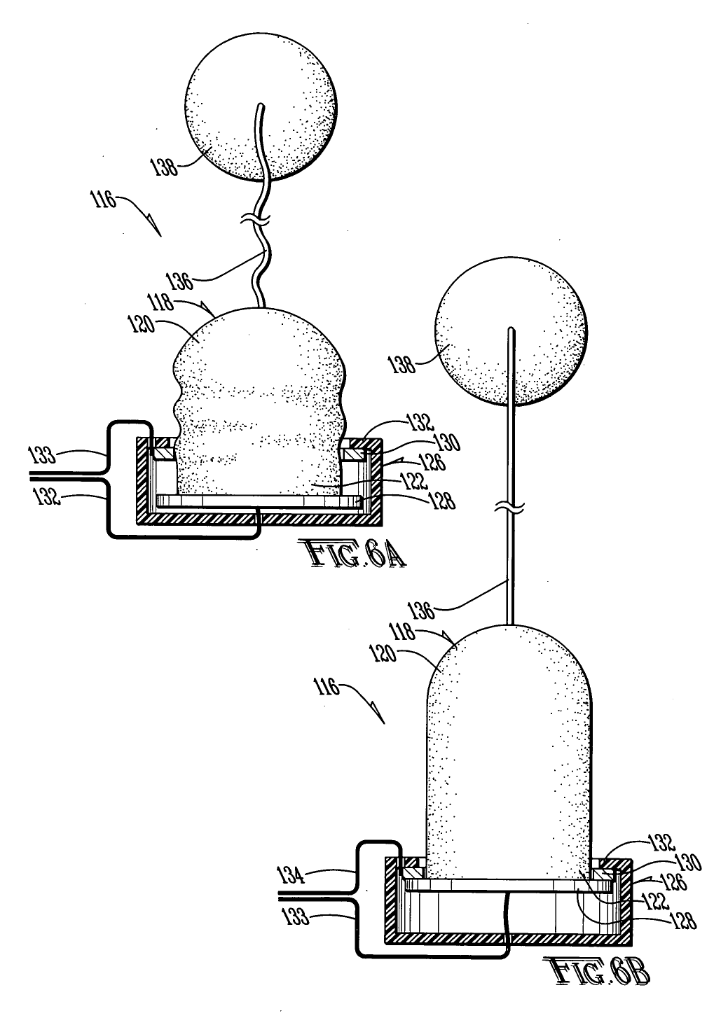

FIG. 5A illustrates a side elevation in cross-section of the switch of the alternative embodiment when the alarm is not actuated; and

FIG. 8B illustrates a side elevation in cross-section of the switch of the alternative embodiment when the alarm is actuated.

### DETAILED DESCRIPTION OF THE PREFERRED EMBODIMENT

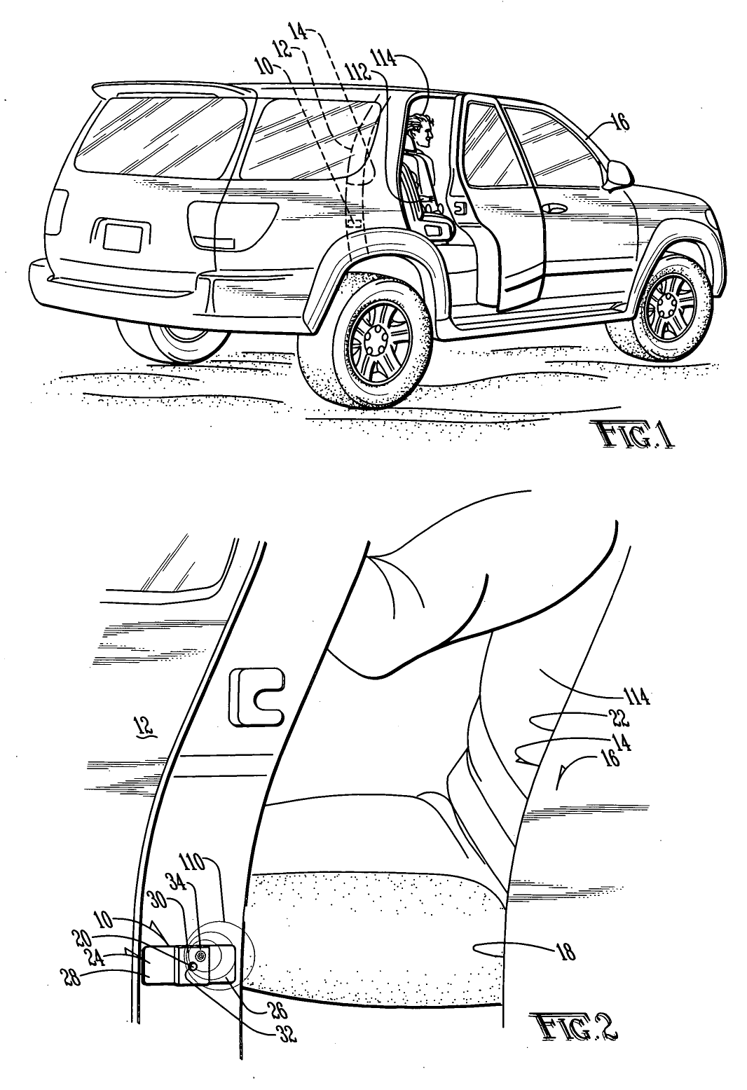

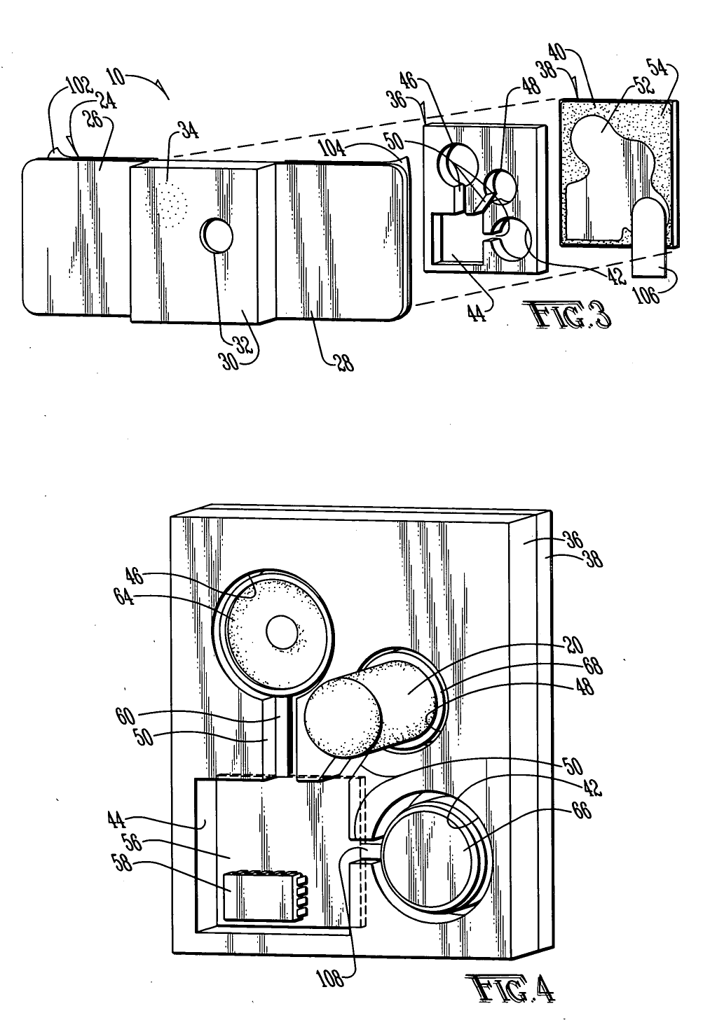

A safety alarm according to the present invention is shown generally as (10) in FIG. 1. As shown, the alarm (10) is shown positioned between a door (12) and frame (14) of a motor vehicle (16). As shown in FIG. 2, the alarm (10) is preferably coupled to the door (12) in a location where closing of the door (12) of the vehicle (16) causes an elevated portion (18) of the door frame (14) to contact a button (20) on the alarm. While it is preferable that the button (20) contact an elevated portion (18) of the door frame (14), the alarm (10) is designed to accommodate variations in the structure of both the door (12) and frame (14) to allow actuation of the button (20) by various portions of the frame (14) which may, in fact, even be recessed portions (22) of the frame (14).

Preferably, however, the alarm (10) is positioned on the door (12) at a location where some space exists between the door (12) and frame (14) when the door (12) of the vehicle (16) is closed so that the closing of the door (12) does not crush or deform other components of the alarm (10). As shown in FIG. 2, the alarm (10) is secured to the door (12) with an adhesive strip (24). While the adhesive strip (24) may be of any type known in the art, and may be of any desired configuration, preferably the adhesive strip (24) is provided with a pair of adhesive tabs (26) and (28) for securement of the alarm (10) to the door (12), and an adhesive center body (30) integrally formed as a unitary piece with the tabs (26) and (28). Preferably the body (30) is provided with an opening (32) to accommodate the button (20) and a vented portion (34). As shown in FIG. 2, the body (30) is preferably slightly wider than the tabs (26) and (28).

As shown in FIG. 3, the alarm (10) includes the adhesive strip (24), a resilient, bendable foam frame (36) and a resilient foam backing (38). Preferably the foam frame (36) is secured to the foam backing (38) by adhesive (40), such as glue, provided between the foam frame (36) and foam backing (38).

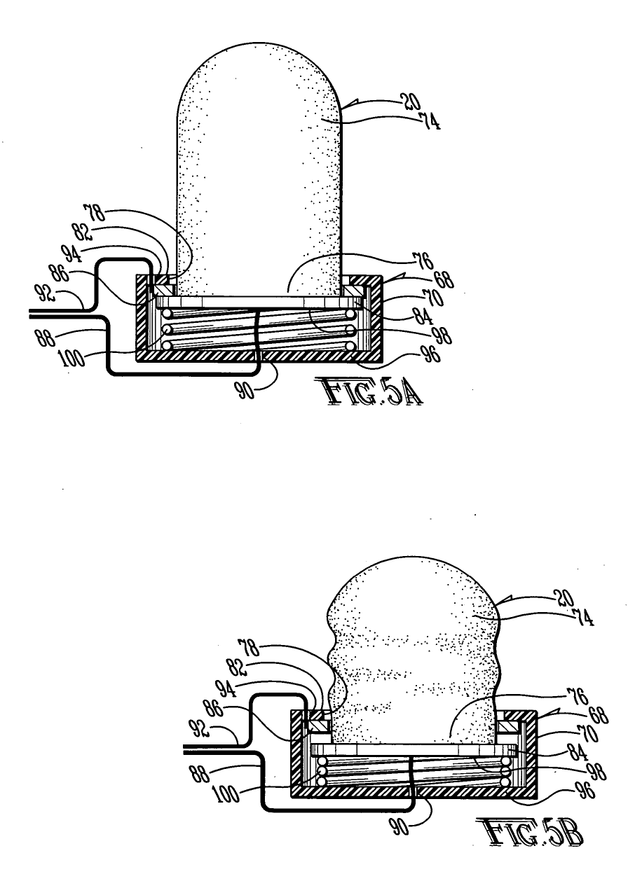

As shown in FIG. 3, the foam frame (36) includes a plurality of cutouts (42), (44), (46) and (48) to accommodate the electrical components of the alarm (10). The frame (36) is also provided with a plurality of channels (50) to accommodate wiring of the electrical components. As shown in FIG. 3, the foam backing (38) is also provided with a slot (52) in fluid communication with the cutout (44) and the area (54) outside of the alarm (10). As shown in FIG. 4, once the foam frame (36) has been adhesively secured to the foam backing (38), a printed circuit (56) having a voice chip (58) is provided within the cutout (44). The printed circuit (56) is preferably coupled to a jack (60) which extends through the slot (52) in the foam frame (36). Such printed circuits (56) and voice chips (58) are known in the art and are available as a shelf item. Preferably, the printed circuit (56) is provided with an accessible read-only memory that has digital voice information stored thereupon. The printed circuit (56) is also preferably provided with other types of memory known in the art to allow additional information to be programmed into the voice chip (58) utilizing a microphone (62) plugged into the jack (60). As shown in FIG. 4, the printed circuit (56) is electrically coupled to a speaker (64). The printed circuit (56) is also electrically coupled to a battery (66), which is preferably a thin circular three-volt manganese oxide/lithium battery, to provide a multi-year lifespan.

As shown in FIG. 4, the printed circuit (56) is also electrically coupled to a pressure sensitive switch (68). In the preferred embodiment, the switch (68) is designed to operate the alarm (10) when the switch (68) is released and to turn off the alarm (10) when the switch (68) is depressed. While any type of pressure sensitive switch (68) known in the art to actuate on release may be used, in the preferred embodiment, the switch is designed as shown in FIGS. 5A-B. As shown in FIG. 5A, the switch (68) includes the button (20), a plastic case (70) and a spring (72). As shown in FIG. 5A, the button (20) includes a cylindrical top (74) of a first diameter, integrally formed with a cylindrical bottom (76) of a second diameter. While the button (20) may be constructed of any suitable material, in the preferred embodiment, the button (20) is constructed of resilient foam having a capability of being deformed to at least one-half of its original height and, more preferably, at least one-eighth of its original height, and return to its original size upon release.

As shown in FIG. 5A, the case (70) is preferably constructed of thin, durable plastic, defining a large opening (78) through which the top (74) of the button (20) extends. The case (70) is preferably cylindrical, with a hollow interior, and the opening (78) is preferably large enough to allow passage of the top (74) of the button (20) therethrough, but small enough to prevent passage of the bottom (76) of the button (20) therethrough, without deformation of the bottom (76).

Positioned around the top (74) of the button (20), between the bottom (76) of the button (20) and the top (82) of the case (70), is a metal contact (84) which, in the preferred embodiment is a steel washer having an inner diameter substantially similar to the diameter of the top (74) of the button (20), and an exterior diameter substantially similar to the diameter of the bottom (76) of the button (20).

A similar contact (86) is adhesively or otherwise secured to the interior top (82) of the case (70). As shown in FIG. 5A, a lead wire (88) coupled to the printed circuit (56) extends through a hole (90) in the case (70) and is coupled to the contact (84). In the preferred embodiment, a sufficient amount of lead wire (88) is provided to prevent the contact (84) from stretching and disengaging from the lead wire (88) during use. Similarly, another lead wire (92) is electrically coupled to the contact (86) through another hole (94) in the case (70). Provided between the bottom (96) of the case (70) and the bottom (98) of the bottom (76) of the button (20) is a spring (100). While the spring (100) may be of any type known in the art, the spring (100) is preferably strong enough to motivate the contact (86) by applying pressure to the bottom (76) of the button (20), and is also preferably capable of compression to at least one-half, and, more preferably, one-eighth its original height, without substantial permanent deformation.

As shown in FIG. 5B, when the button (20) is depressed, the bottom (76) of the button (20) pulls the contact (84) out away from the contact (86) coupled to the case (70). As both the spring (100) and button (20) are compressible, even a slight pressure on the button (20) will move the contacts (84) and (86), while a large forceful movement of the button (20) will be accommodated by the button (20) and spring (100) without permanent deformation of the button (20) or damage to the case (70). As shown in FIG. 4, the switch (68) is provided within the cutout (46) of the foam frame (36) to the printed circuit (56). Once the electrical components have been provided within the foam frame (36), the adhesive strip (24) is provided over the foam frame (36) with the button (20) extending through the opening (32) of the adhesive strip (24), and the speaker (64) positioned below the vented portion (34) of the adhesive strip (24).

When it is desired to operate the alarm (10) of the present invention, protective backing strips (102) and (104) are removed from the adhesive strip (24) and the tabs (26) and (28) are secured to the door (12) of the vehicle (16). As noted above, the alarm (10) is preferably positioned in an area along the door (12) where, when in the closed position, the frame (14) is sufficiently close to the door to depress the button (20), yet far enough away from the door (12) to prevent the frame (14) from crushing the electrical components associated with the alarm (10). Once such a position along the door (12) has been located and the tabs (26) and (28) utilized to secure the alarm (10) to the door (12), a strip of non-conductive material (106) provided between the battery (66) and a connection (108) with the printed circuit (56) is removed.

The printed circuit (56) then converts the digital information associated with the voice chip (58) to an analog signal, which is then amplified in a manner such as that known in the art, and relayed to the speaker (64). The speaker (64) converts the analog signal into voice sounds which, in the preferred embodiment, are a warning such as “Where's the Baby?” or “Don't leave the dog in the car.” Alternatively, the sounds (110) may be an alarm or buzzer sound, or any other suitable warning desired. If an alternative sound (110) is desired, the microphone (62) may be coupled to the jack (60) and used to record a customized sound which the printed circuit (56) converts to a digital signal stored in the voice chip (58), and later converted to an analog signal broadcast by the speaker (64) in a manner such as that described above.

In use, a child (112) or pet (not shown) may be placed within the vehicle (16). When the driver (114) opens the door (12) to the vehicle (16) to exit the vehicle (16), the door frame (14) is moved out of engagement with the button (20), thereby causing the speaker (64) to broadcast the sounds (110) stored on the voice chip (58). Upon hearing the warning sounds (110), the driver (114) checks the vehicle (16) to be sure the child (112) is not inadvertently left in the vehicle (16). Once the driver (114) closes the door (12), the frame (14) again contacts the button (20), thereby deactuating the alarm (10) and causing the speaker (64) to stop broadcasting the sounds (110).

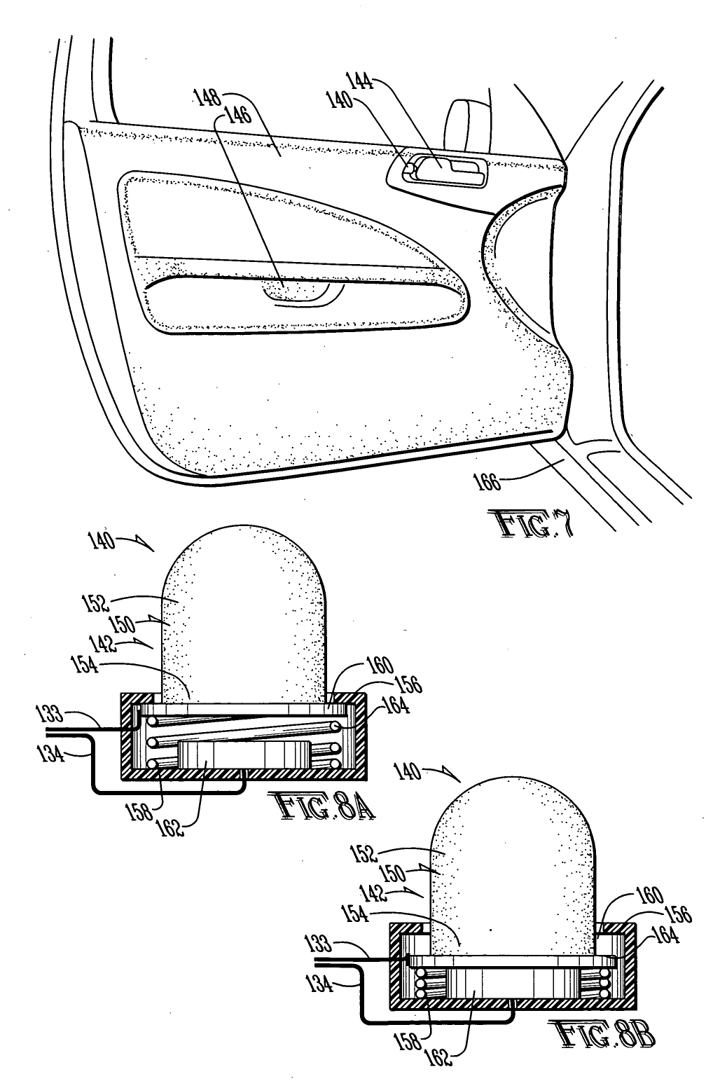

An alternative switch associated with the alarm (10) of the present invention is shown generally as (116) in FIGS. 6A-B. As shown, the switch (116) includes a button (118) having a cylindrical top (120) and cylindrical bottom (122). In this embodiment, the button (118) is preferably constructed of rigid material, but may still be constructed of resilient material if desired. A hard plastic case (126) is constructed in a manner similar to that described above. Provided around the cylindrical top (120) of the button (118) and secured to the bottom (122) of the button (118) is a contact (128) which, in the preferred embodiment, is a steel washer. Another contact (130) is coupled to the top (132) of the case (126) around the top (120) of the button (118). In a manner such as that described above, one contact (128) is coupled to a first lead wire (133) and the other contact (130) is coupled to another lead wire (134). In this embodiment, the spring and long resilient top are eliminated and a resilient cord (136) or the like is coupled to the top (120) of the button (118).

As shown in FIGS. 6A and 6B, the cord (136) is also coupled to an adhesive patch (138). Preferably, the adhesive patch (138) is strong enough and secured well enough to the cord (136) so that the adhesive patch (138) when secured to the frame (14) of the vehicle (16) does not become dislodged from the frame (14) even if the cord (136) is stretched to twice, and more preferably, eight times its original length.

As shown in FIG. 6B, when the button (118) is secured to the door (12) in a manner such as that described above, and the adhesive patch (138) is secured to the frame (14) in a manner such as that described above, opening of the door (12) causes the cord (136) to be stretched, thereby causing the top (120) of the button (118) to be pulled toward the frame (14) which, in turn, causes the contacts (128) and (130) to move into electrical contact with one another. Conversely, when the door (12) is closed, the frame (14) pushes against the top (120) of the button (118), thereby moving the contacts (128) and (130) out of electrical contact with one another, and deactivating the alarm (10).

An alternative alarm associated with the present invention is shown generally as (140) in FIG. 7. As shown, the alarm (140) is coupled to a latch (144) or handle (146) of a car door (148). As shown in FIG. 8A, the switch (142) includes a button (150) having a cylindrical top (152) and a cylindrical bottom (154). As noted above, the button (150) may be constructed of rigid or, preferably, of a resilient material such as a closed cell foam. A hard plastic case (156) is constructed in a manner similar to that described above. Secured to the bottom (158) of the button (150) is an electrical contact which, in the preferred embodiment, is a steel disc (160). A steel cylinder (162) having a diameter smaller than the diameter of the bottom (158) of the button (150) is secured to the bottom of the hard plastic case (156). Provided around the cylinder (162) is a resilient coil spring (164) which biases the button (150) away from the cylinder (162). In this embodiment, the steel disc (160) is coupled to the first lead wire (133) and the steel cylinder (162) is coupled to the other lead wire (134). As shown, when the button (150) is not depressed, the spring (164) biases the steel disc (160) out of contact with the cylinder (162). As shown in FIG. 7, the alarm (140) is preferably coupled to the latch (144) or handle (146) in a manner such that the button (150) is not depressed. (FIGS. 7, 8A-B). When a user grabs the latch (144) or handle (146), the user depresses the button (150), thereby triggering the alarm (140). This embodiment may be desirable if it is not possible to locate the alarm (140) between the door (148) and frame (166) of the vehicle, or if it is desired to keep the alarm (140) within view.

Although the invention has been described with respect to a preferred embodiment thereof, it is also to be understood that it is not to be so limited, since changes and modifications can be made therein which are within the full, intended scope of this invention as defined by the appended claims. As an example, the adhesive strip (24) may be secured to the frame (14) rather than the door (12) to cause the door (12), rather than the frame (14) to actuate the button (20) upon opening and closing of the door (12). It should also be noted that the alarm (10) may be constructed of any suitable dimensions and configurations, used in association with any desired electrical components and power sources, and may be actuated by solar or kinetic power. Alternatively, the alarm (10) may be wired directly to the electrical system associated with the vehicle (16).

What is claimed is:

1. A child safety sensor for a vehicle comprising:
(a) a first sensor;
(b) a second sensor;
(c) means for releasably engaging said first sensor with a door of the vehicle;
(d) means for generating a sound; and
(e) means for actuating said sound generating means in response to said first sensor moving into relationship to said second sensor.

2. The child safety sensor for a vehicle of claim 1, wherein said engaging means is adhesive.

3. The child safety sensor for a vehicle of claim 2, wherein said sound generating means is a speaker.

4. The child safety sensor for a vehicle of claim 1, further comprising a battery coupled to said speaker.

5. The child safety sensor for a vehicle of claim 4, wherein said battery weighs less than five hundred grams.

6. The child safety sensor for a vehicle of claim 1, wherein said first sensor is a first electrical contact, and said second sensor is a second electrical contact.

7. The child safety sensor for a vehicle of claim 6, further comprising a battery coupled to said first sensor.

8. The child safety sensor for a vehicle of claim 7, wherein said battery weighs less than five hundred grams.

9. The child safety sensor for a vehicle of claim 1, wherein said sound generating means is means for generating the sound of a word.

10. The child safety sensor for a vehicle of claim 1, wherein said sound generating means is means for generating the sound of a plurality of words.

11. The child safety sensor for a vehicle of claim 1, wherein said first engaging means comprises means for releasably securing said first sensor within said door of the vehicle.

12. The child safety sensor for a vehicle of claim 11, further comprising a supplemental engaging means comprising a resilient actuator releasably secured to said door of the vehicle.

13. The child safety sensor for a vehicle of claim

14. A child safety sensor for a vehicle comprising:
(a) a speaker;
(b) a batty coupled to said speaker;
(c) first means for releasably securing said speaker to the vehicle;
(d) a second means for releasably securing said battery to the vehicle;
(e) a first sensor releasably coupled to said vehicle;
(f) a second sensor releasably coupled to said vehicle; and
(g) means coupled to said speaker for actuating said speaker in response to said first sensor moving relative to said second sensor.

15. The child safety sensor for a vehicle of claim 14, wherein said first sensor is releasably secured to a door of said car.

16. The child safety sensor for a vehicle of claim 15, wherein said first sensor is releasably secured to a frame of said car.

17. The child safety sensor for a vehicle of claim 15, further comprising means for moving said first sensor out of contact with said second contact when a door of the vehicle is open and for moving said first sensor into contact with said second contact when said door of the vehicle is closed.

18. The child safety sensor for a vehicle of claim 15, further comprising means for moving said first sensor into contact with said second contact when a door of the vehicle is open and for moving said first sensor out of contact with said second contact when said door of the vehicle is closed.

19. A child safety sensor for a vehicle comprising:
(a) a speaker;
(b) a battery weighing less than one kilogram;
(c) means for sensing opening of a door of the vehicle;
(d) means coupled to said battery, said speaker and said sensing means for actuating said speaker in response to said sensing means sensing opening of a door of the vehicle; and
(e) means for releasably securing said speaker, said battery, said sensing means and said actuating means to the vehicle within 0.5 meters of one another.

20. The child safety sensor for a vehicle of claim 19, wherein said securing means is adhesive.
